(19) United States
(12) Patent Application Publication
(10) Pub. No.: US 2008/0243962 A1
(43) Pub. Date: Oct. 2, 2008

(54) Method and apparatus for providing and managing a virtual storage namespace

(76) Inventor: Yasuyuki Mimatsu, Cupertino, CA (US)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/730,224

(22) Filed: Mar. 30, 2007

(51) Int. Cl. G06F 12/00

(52) U.S. Cl. 707/205

(57) ABSTRACT

The namespace of file system objects in a storage system includes a namespace table for maintaining virtual namespaces for each client computer. The storage system maintains an information holding a correspondence between real names for file system objects and virtual names for the file system objects. The virtual names are registered in the information according to individual client computers in communication with the storage system. When the storage system receives an operation request from a client computer, the storage system determines whether the operation request includes a virtual name a file system object that is a target of the operation request. The storage system replaces the virtual name in the operation request with a corresponding real name by referring to the information and an ID of the client computer that sent the operation request. The operation is carried out using the real name in place of the virtual name.

### BACKGROUND OF THE INVENTION

1. Field of the Invention

The present invention relates generally to management of storage systems having file systems.

2. Description of Related Art

Today's large storage systems are highly reliable and are able to provide high-performance data storage and retrieval with multiple computers. One type of storage system commonly in use is known as a network attached storage (NAS) system. A NAS system typically includes a file system interface. The file system interface allows NAS clients (i.e., application programs on computers which access data in the NAS system) to share files and directories in the NAS system. NAS systems rely on some standardized file system interface protocols, such as the Network File System (NFS) protocol.

NAS systems sometimes may handle requests from a large number of client computers. For example, scientific computation systems can use NAS systems to store datasets to be processed. The dataset is divided into a number of pieces by a coordinator and the pieces are processed by a large number of client computers in parallel. Massively parallel computation is necessary to obtain accurate results for large calculations in a short amount of time. Each particular client in such a system usually has its own configuration file that defines which file systems the particular client mounts within the NAS, which files the particular client reads, what file names the particular client outputs results to, and so forth, so that each particular client processes subsets of data assigned to the particular client.

However, some problems exist in the prior art in such configurations. First, the client computers that process the data are generally less reliable than the NAS system itself, which means that the configuration of the application can be easily lost if one or more of the computers fail. When failed computers are replaced or new computers are added to the system, clients are installed in these computers and the system administrator must log in to each client computer and edit the client application configurations. Also, when the number of pieces of dataset, number of clients to be used, file systems to be accessed, and/or names of files which clients access are changed, the configuration information in each client must be updated. These management and maintenance operations can be complicated and time-consuming, requiring administrators to log in to each client computer locally or remotely and edit the configurations.

### BRIEF SUMMARY OF THE INVENTION

The invention includes methods and apparatuses for managing the namespace of objects in a storage system for each client so that the administrator does not have to manage application configuration information for each client individually. These and other features and advantages of the present invention will become apparent to those of ordinary skill in the art in view of the following detailed description of the preferred embodiments.

### BRIEF DESCRIPTION OF THE DRAWINGS

The accompanying drawings, in conjunction with the general description given above, and the detailed description of the preferred embodiments given below, serve to illustrate and explain the principles of the preferred embodiments of the best mode of the invention presently contemplated.

FIG. 1 illustrates an example of a hardware configuration in which the method and apparatus of the invention may be applied.

FIG. 2 illustrates an example of a name space table which may be maintained for each client.

FIG. 3 illustrates an example of a file handle table.

FIG. 4A illustrates a conceptual diagram of an embodiment of the invention.

FIG. 4B illustrates an example of a storage system control program according to the invention.

FIG. 5 illustrates an example of processing of a management command.

FIG. 6 illustrates an example of a process to convert names included in the operation.

FIG. 7 illustrates an example of a process to update the file handle table.

FIG. 8 illustrates an example of a process to convert names included in the response.

### DETAILED DESCRIPTION OF THE INVENTION

In the following detailed description of the invention, reference is made to the accompanying drawings which form a part of the disclosure, and, in which are shown by way of illustration, and not of limitation, specific embodiments by which the invention may be practiced. In the drawings, like numerals describe substantially similar components throughout the several views. Further, the drawings, the foregoing discussion, and following description are exemplary and explanatory only, and are not intended to limit the scope of the invention or this application in any manner.

As discussed above, if there are a large number of clients that access different objects in a storage system, the configuration must be individually set for each client by an administrator. Under the invention, configuration information is concentrated and stored into the storage system. When the storage system receives a file operation from a client, the storage system identifies the client and converts the names of objects included in the operation or in a response according to the configuration information, so that each client is able to issue an identical operation but access different data. Thus, the invention manages the namespace of objects in the storage system for each different client so that the administrator does not have to individually manage application configuration information in each client.

System Structure

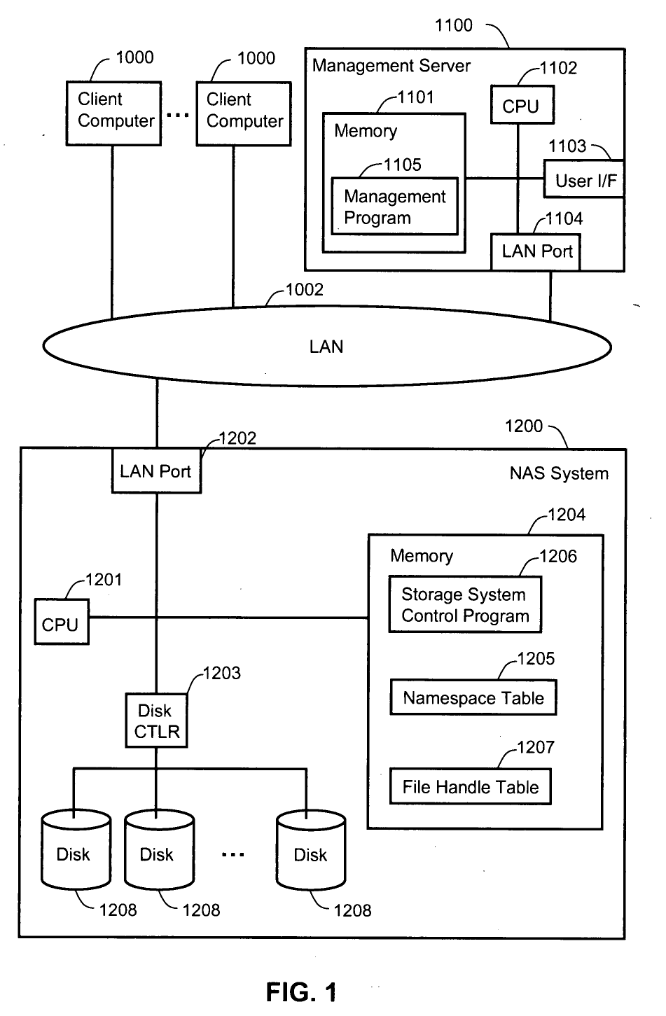

FIG. 1 illustrates an overview of an exemplary information system in which the method and apparatus of the invention may be applied. The information system includes a plurality of client computers 1000 connected for communication with a NAS system 1200 via a network 1002, such as a local area network (LAN), although other network types may also be used. Client computers 1000 include application programs or other software (not shown) that access files stored in the NAS, such as via read and write commands, using NFS or other suitable protocols.

The NAS system 1200 and the configuration information for NAS system 1200 may be controlled by an administrator from a management server 1100 also connected for communication via network 1002. Management server includes a CPU 1102 that executes a management program 1105 loaded in a memory 1101. Management server 1100 is able to communicate with the administrator through a user interface 1103, and with the NAS system 1200 through a LAN port 1104 that connects management server 1100 to network 1002.

NAS system 1200 includes a LAN port 1202 to connect NAS 1200 to network 1002, a CPU 1201 and a memory 1204. NAS 1200 also includes one or more disk controllers 1203 for controlling and communicating with a plurality of storage devices 1208. Storage devices 1208 are preferably hard disk drives able to store and retrieve data under the control of disk controller 1203, although other types of storage devices may be used. The physical storage space provided by storage devices 1208 is combined and/or divided by NAS system 1200 into one or more logical volumes, and one or more file systems are created in these logical volumes to provide allocated storage capacity and namespaces to the client computers 1000.

NAS system 1200 may further include a storage system control program 1206, a namespace table 1205, and a file handle table 1207 for carrying out the invention. CPU 1201 executes storage system control program 1206 in memory 1204. Storage system control program 1206 processes file or file system operations sent from the clients. The processing includes well-known file operations, such as read and write commands, and other processes related to this invention as described below. Storage system control program 1206 also communicates with the management server 1100 and processes management requests.

As discussed above, NAS 1200 may also maintain in memory 1204 namespace table 1205, which is a first information defining the mapping between virtual names and real names, and file handle table 1207, which is a second information that maintains records of virtual names corresponding to file handles used by clients. These tables are discussed in detail below.

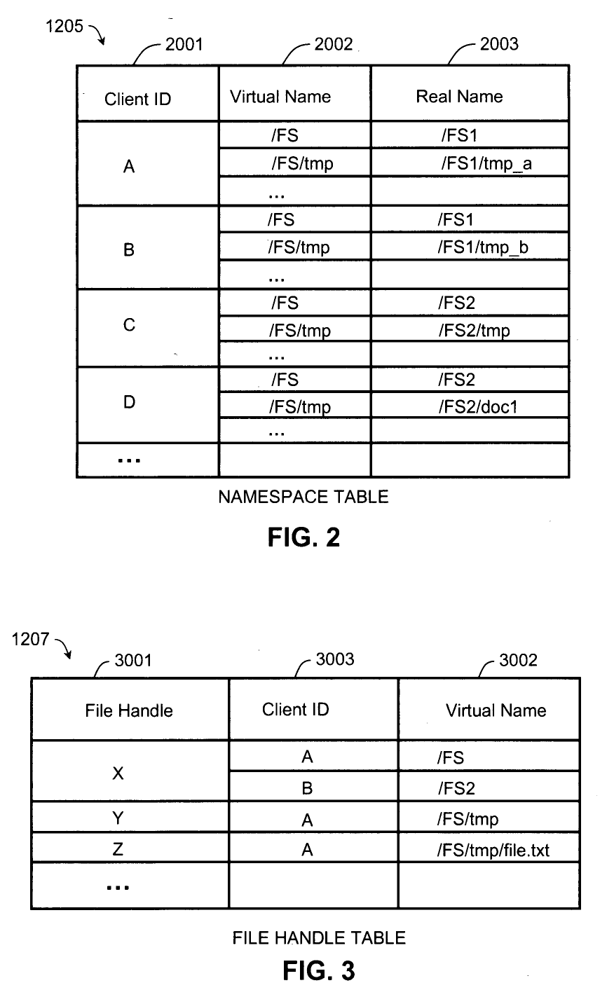

As illustrated in FIG. 2, for each client, namespace table 1205 contains a client ID 2001 which is used to identify a client, a virtual name 2002 which is a name of a file system object exposed to clients, and a real name 2003 which is an actual name (e.g., file system path name) of an object corresponding to the virtual name. Thus, a real name might be an actual path for a file or a directory or some other file system object, while a virtual name might be a generic path or other designation for a file system object that a client application might use. For example, FIG. 2 illustrates that if client A or B tries to access an object, such as the file system having the virtual name “/FS”, these clients actually access the file system named “/FS1” in NAS 1200. On the other hand, if client C tries to access an object that has the same virtual name, i.e., “/FS”, client C actually accesses the file system named “/FS2” in NAS 1200.

The client ID 2001 is sent from clients along with any file or file system operations. For example, the client ID may in actual implementation be an IP address of the particular client computer. Another example of a client ID may be a user ID and/or group ID. Further, if a name specified by a client in a request is not registered as a virtual name in the namespace table 1205, the name included in the request is processed as a real name. For example, if a client tries to access “/FS3” and the name is not registered as a virtual name for the client, the client accesses the file system “/FS3”, or NAS 1200 returns an error if “/FS3” does not exist. Because the conversion from virtual name to real name is defined for each client, the invention allows two clients to share one object. One client is able to access the object by specifying a first virtual name and another client is able to access the object by specifying another virtual name or the real name.

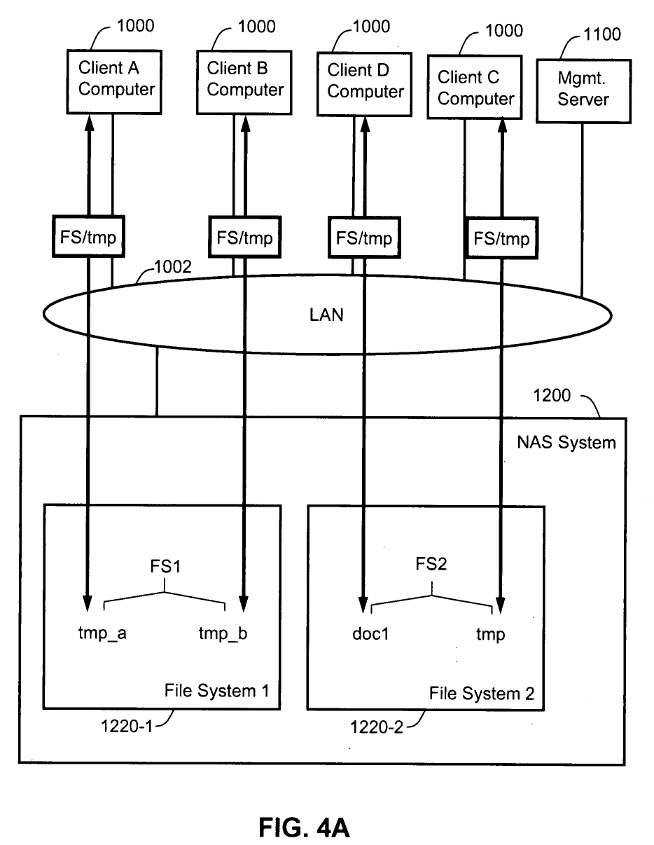

File handle table 1207 may also be provided according to the invention. As illustrated in FIG. 3, for each file handle created by NAS 1200, file handle table 1207 contains the file handle 3001 and the corresponding virtual name 3002 that is a full path to a file object and corresponds to the file handle 3001. A client ID 3003 associated with each file handle and corresponding virtual name is also included in file handle table 1207, and thus, the same file handle 3001 may be associated with a first virtual name for one client and with other virtual names for other clients. File handles are usually created as shortcuts for internal use in a storage system. The creation, use and deletion of file handles for real names is well-known in file or file system operations.

Process of Operations

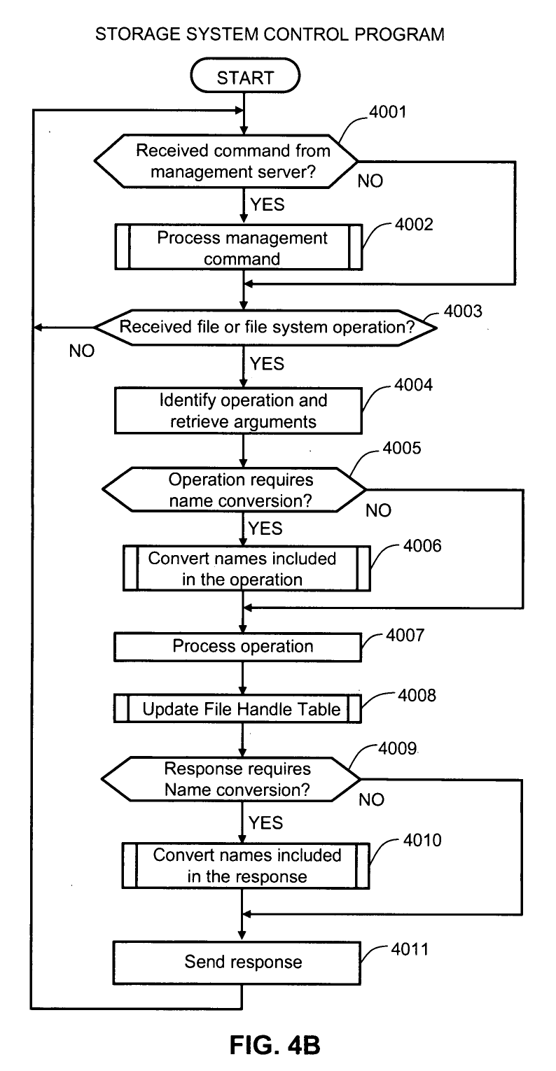

FIG. 4A illustrates a conceptual diagram of an embodiment of the invention to aid in explanation of the function of the invention under storage system control program 1206 of the invention. In FIG. 4A a first file system 1220-1, named “File System 1”, and a second file system 1220-2, named “File System 2” are stored on NAS system 1200 and able to be accessed by client computers 1000. As illustrated in FIG. 4A and FIG. 2, client computers A-D each send an operation including the same virtual name “FS/tmp”. NAS system 1200 refers to the namespace table 1205, and determines that each client actually intends to operate on a different file, directory, or other file system object. For example, Client A accesses “FS1/tmp_a”, Client B accesses “FS1/tmp_b”, Client C access “FS2/tmp” and Client D accesses “FS2/doc1”. Thus, while each of Clients A-D might make the same operation request, the NAS system 1200 is automatically able to determine which file system object each client 1000 is actually intending to operate on, and then respond accordingly. Numerous other variations are possible under the invention, with it being understood that the foregoing examples are provided for explanation purposes, and that the foregoing examples in no manner limit the utility or scope of the invention.

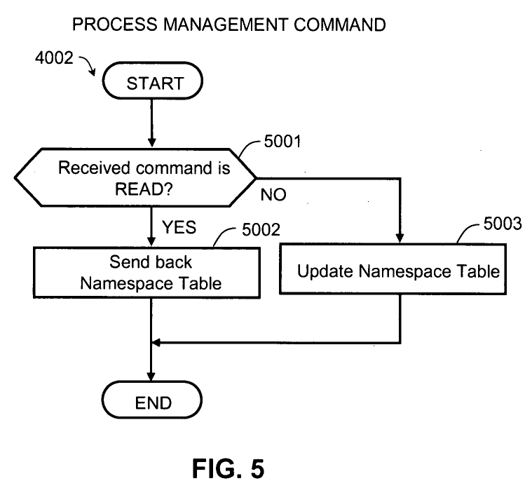

FIG. 4B illustrates the flow of storage system control program 1206 to process received file or file system operations from clients 1000 and management requests from management server 1100. At step 4001, if NAS 1200 receives a management request from management server 1100, then at step 4002, storage system control program 1206 processes the management request. The details of step 4002 are set forth in FIG. 5, described below.

At step 4003, on the other hand, if NAS 1200 receives a file or file system operation, storage system control program 1206 processes the operation as set forth in steps 4004-4011. Otherwise, the process returns to step 4001 for receiving the next request.

After receiving a file or file system operation at step 4003, then at step 4004, storage system control program 1206 identifies what operation has been received and retrieves the arguments of the operation included with the request.

At step 4005, the process determines whether the operation requires name conversion, i.e., whether the operation includes one or more names that might be virtual names of one or more file system objects that need to be converted to real names. For example, the following NFS operations include names as arguments: MNT, UMNT, LOOKUP, CREATE, MKDIR, MKNOD, REMOVE, RMDIR, RENAME, and LINK. Accordingly, if one of these operations is received, then it is possible that a virtual name might be included in the operation, and the process goes to step 4006. On the other hand, if no names are included in an operation, then the process skips to step 4007.

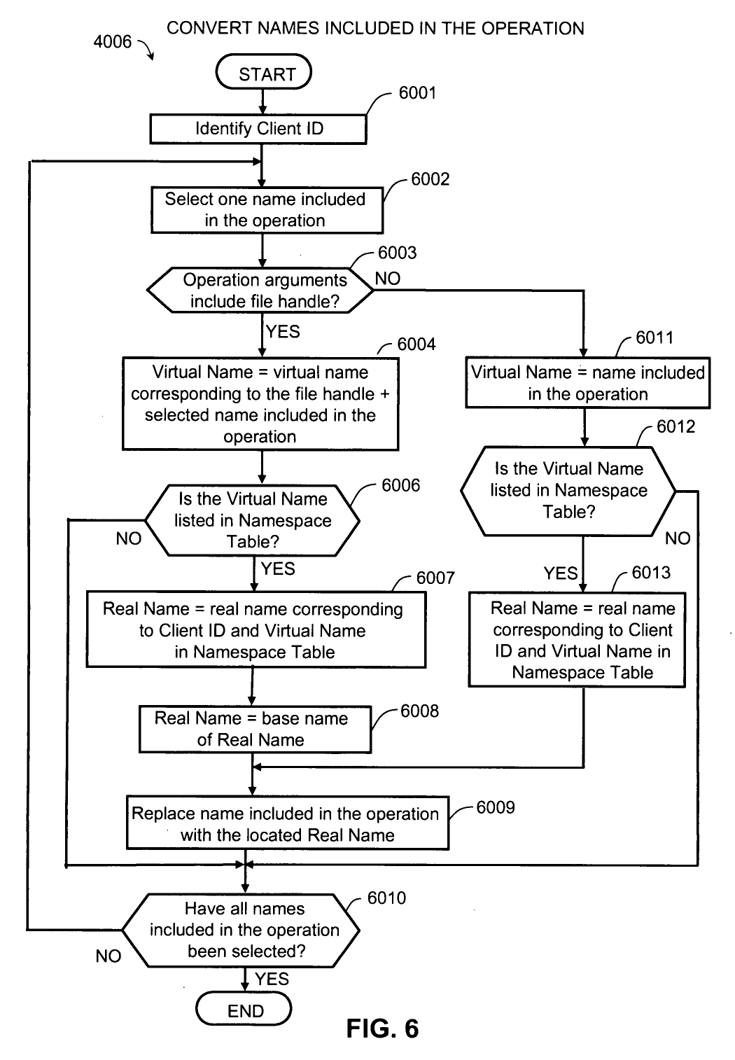

At step 4006, storage system control program 1206 converts any virtual names included in the operation into real names using the process set forth in detail in FIG. 6, explained below.

At step 4007, storage system control program processes the requested operation, which may now include any virtual names converted to real names as a normal operation, such as a normal NFS operation.

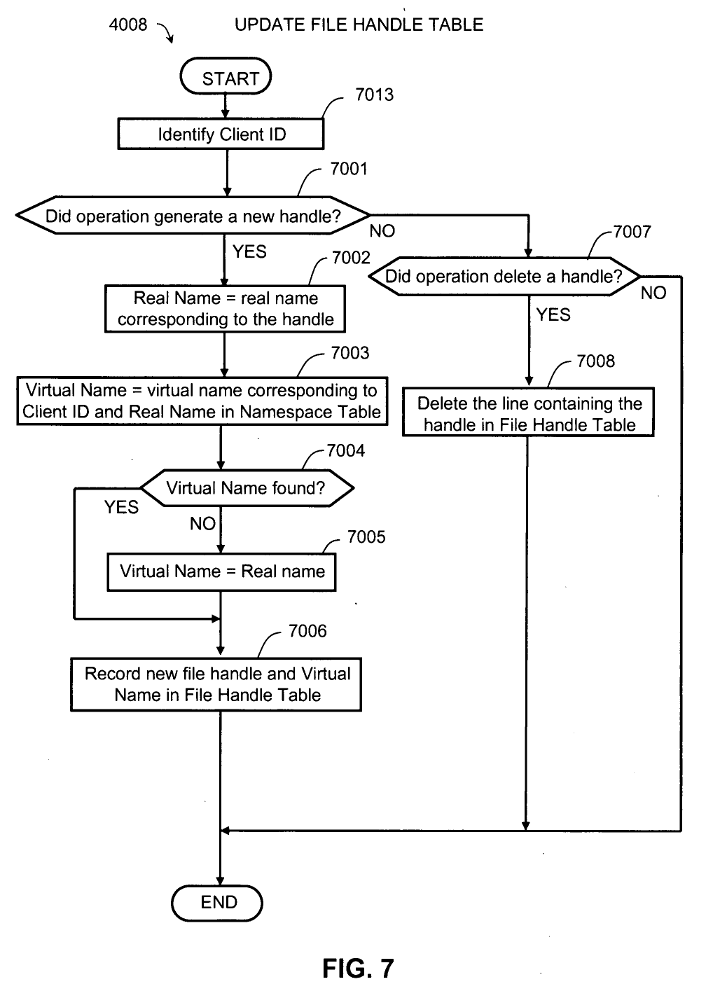

At step 4008, after the processing of the requested operation is completed, storage system control program 1206 updates file handle table 1207 based on the results of the operation. The details of step 4008 are set forth in FIG. 7, explained below.

At step 4009, the process determines whether a response to the client is required as a result of the processing of the operation. Also, if a response is required, then the process determines if the response requires name conversion.

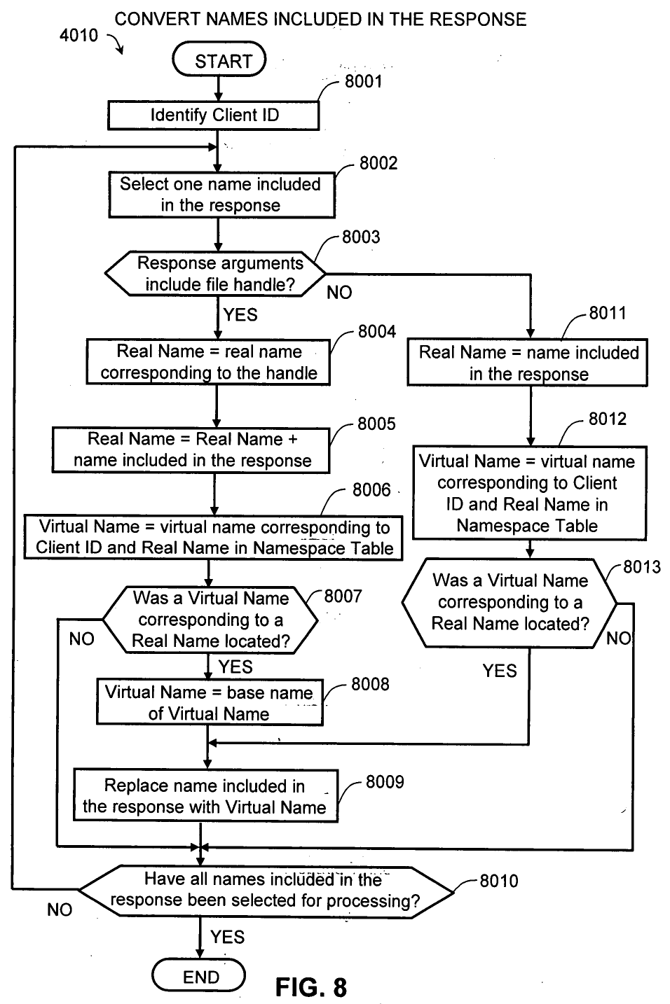

At step 4010, when name conversion of a response is required, then before the response is sent back to the client, real names of the object(s) are converted into virtual names. The details of step 4010 are set forth in FIG. 8, and described below.

At step 4011, the storage system control program 1206 sends the response, which may include converted names, to the requesting client and returns to step 4001 to process the next request.

FIG. 5 illustrates the details for carrying out step 4002 in which a management command is processed by storage system control program 1206. Under the invention, there are two kinds of management requests: READ and UPDATE. A READ request is a request to send a namespace table 1205 from NAS system 1200 to management server 1100. An administrator can edit the namespace table 1205 on the management server 1100, and then send the edited namespace table back to the NAS system using an UPDATE command to update the namespace table 1205 in NAS 1200. Thus, at step 5001, the process determines whether the command is a READ request. If the request is a READ request, the process goes to step 5002 to send back a requested namespace table. On the other hand, if the request is not a READ request, then the request is an UPDATE request, and the process goes to step 5003 to update the namespace table 1205 using the namespace table included with the UPDATE request. The UPDATE request provides a means for administrators to register virtual names in namespace table 1205 for use by client computers 1000. Further, in other implementations, it is possible to expose the namespace table as a file to the clients and/or the management server via a file I/O path and then update the namespace table by modifying the file.

FIG. 6 illustrates the details for carrying out step 4006 to convert any virtual names included in the operation to real names. Clients always use virtual names, that is, names included in operations are always at least a part of a virtual name. The mapping from virtual to real names is stored in name space table 1205. The storage system internally converts virtual names to real names by referring to tables 1205 and 1207. Thus, if an operation has a file handle, this is also referred to for identifying the full virtual name. However, if a virtual name is not recorded in the namespace table, then name conversion is not necessary, that is, the real name is identical to the virtual name.

At step 6001, storage system control program 1206 identifies the client that sent the operation. As discussed above, this may be done using an IP address, a user name, a combination of group name and user name, or by other methods for assigning identifiers to the clients 1000.

At step 6002, the process selects one name to be converted from the operation. Some operations which require name conversion may include not only file names but also a file handle.

At step 6003, the process determines whether a file handle is included in the operation. If a file handle is included, the process goes to step 6004. On the other hand, if a file handle is not included in the operation, then the process proceeds to step 6011.

At step 6011, the selected name of the operation solely represents the full virtual name because the operation has no handle of a file/directory which would be a part of the virtual name. For example, NFS operations MNT (mount) and UMNT (unmount) are such operations.

At step 6012, the storage system control program 1206 searches namespace table 1205 under the identified client ID to determine if the selected name is listed as a virtual name in the namespace table 1205 for the identified client ID.

At step 6013, when the virtual name 2002 that matches the selected name is located in the namespace table 1205 for the identified client ID 2001, then the process identifies from namespace table 1205 the real name 2003 that corresponds to the identified virtual name 2002. On the other hand, if no virtual name match is found in namespace table 1205 for the selected name for the identified client, then the selected name is a virtual name which is identical to its real name that does not have to be converted, and the process goes to step 6010.

Returning to step 6003, some operations identify a file object by using a file handle and a file name. For example, NFS operations including LOOKUP, CREATE, MKDIR and so on, the file handle identifies the directory in which a file object whose name is identified by a file name is manipulated. So, in this embodiment, a full virtual name can be made by concatenating a virtual path corresponding to a file handle and a virtual name included in the operation.

If the operation includes a file handle in addition to the selected name, then at step 6004, storage system control program 1206 refers to file handle table 1207 to obtain a virtual name 3002 corresponding to the file handle 3001 and a client ID 3003. The virtual name 3002 corresponding to the file handle 3001 and the client ID 3003 is a full path of a directory which contains a file system object specified by the selected name in the operation. A full concatenated virtual name 2002 is obtained by concatenating the virtual name 3002 obtained above with the selected name included in the operation.

At step 6006, storage system control program 1206 refers to namespace table 1205 and searches namespace table 1205 for a real name that corresponds to the concatenated virtual name if the concatenated virtual name matches a virtual name listed for the identified client ID. If no virtual name in namespace table 1205 matches the concatenated virtual name for the identified client, then the concatenated name is identical to its real name that does not have to be converted, and the process skips to step 6010.

On the other hand, if the concatenated name matches a virtual name 2003 listed in namespace table 1205 for the identified client, then at step 6007, the process identifies the real name 2003 that corresponds to the identified virtual name 2002, and goes to step 6008.

At step 6008, storage system control program 1206 extracts the base name of the real name, i.e., the last component of the real name. Since the original name included with the operation is a virtual name, the virtual name needs to be replaced in the operation with the real name. Additionally, since the operation includes a file handle, only the base portion of the real name replaces the virtual name in the operation. For example, when a file handle is assigned to a virtual name ‘/usr/lib’ which corresponds to a real name ‘/clientX/usr/lib’ and a virtual name ‘/usr/lib/library.lib’ is defined for a real name ‘/clientX/usr/lib/libraryA.lib’. Then, for example, a NFS REMOVE operation that includes the file handle and a file name ‘library.lib’ is supposed to remove a file whose real name is ‘/clientX/usr/lib/libraryA.lib’. So, in order to process the operation by a conventional NFS server at step 4007 in FIG. 4B, the virtual name ‘library.lib’ included in the operation will be replaced with the real name ‘libraryA.lib’. Further, it should be noted that the mapping of a file handle and a real name is typically maintained by a storage system as a part of well-known file system management techniques so that the file handle in the operation does not have to be changed.

At step 6009, the process replaces the selected original name in the operation with the real name obtained at step 6008 or 6012.

At step 6010, the process determines whether all names in the operation have been selected and processed. Steps 6002-6013 are repeated until all names in the operation have been selected and processed, and then the process for converting names ends, and the main process of FIG. 4B proceeds to step 4007.

FIG. 7 illustrates the details of step 4008 of FIG. 4B for updating the file handle table. At first, at step 7013, storage system control program identifies the client ID of the client that sent the operation. This may actually take place during processing of step 4006 of FIG. 4B, as described above, or in another manner. After processing of the operation at step 4007 of FIG. 4B, then at step 7001, it is determined if a new file handle has been generated. If a new file handle was generated, the process goes to step 7002. On the other hand, if a new file handle was not generated, the process goes to step 7007.

At step 7002, storage system control program 1206 identifies a real name corresponding to the newly generated file handle. The mapping between file handles and real names (i.e., full paths to files) is typically maintained by a storage system as a part of well-known file system management techniques. Accordingly, the specifics do not need to be discussed here.

At step 7003, the process refers to namespace table 1205 and searches for a virtual name 2003 registered to the identified client ID and corresponding to the real name identified in step 7002 that corresponds to the newly-generated file handle.

At step 7004, if the identified real name is located in the namespace table 1205, then a virtual name has been designated for the real name for that client, and the process skips to step 7006. On the other hand, if an entry for a virtual name is not found in the namespace table 1205, the process goes to step 7005.

At step 7005, the real name identified in step 7002 will be used as the “virtual” name 3002 for recording in the file handle table 1207.

At step 7006, storage system control program records the new file handle 3001 and virtual name 3002 in file handle table 1207, and this portion of the process ends.

If it was determined at step 7001 that the operation did not generate a new file handle, then at step 7007, the process determines whether an existing file handle has been deleted by the operation. If a file handle has been deleted, the process goes to step 7008. If a file handle was not deleted, then there is no need to update the file handle table 1207, and this portion of the process ends.

At step 7008, the process locates the line in the file handle table that includes the deleted file handle, and deletes the corresponding line.

FIG. 8 illustrates the details of step 4010 of FIG. 4B carried out when the response to the operation requires name conversion. Responses of some operations, for example, NFS operations DUMP, EXPORT, READLINK, READDIR, READDIRPLUS, include names that must be converted from real names to virtual names before the response is sent to the requesting client. The process set forth in FIG. 8 is generally the reverse of the process for conversion from real names to virtual names, as described above with reference to FIG. 6.

At step 8001, the client ID is identified. This may have been carried our earlier, or may be gathered from the response.

At step 8002, one of the real names included in the response is selected for processing.

At step 8003, the response is checked to determine whether a file handle is included. If a file handle is included, the process goes to step 8004. If a file handle is not included, the process goes to step 8011.

At steps 8011-8012, the selected name is checked to determine whether the selected name has a corresponding virtual name assigned for that client. Accordingly, at steps 8011-8012, the storage system control program 1206 searches namespace table 1205 under the identified client ID to determine if the selected real name is listed as a real name 2002 in the namespace table 1205, and has a corresponding virtual name 2003 registered in the namespace table 1205 for the identified client ID 2001.

At step 8013, when a virtual name has been located in the namespace table for the identified client ID and real name, the process goes to step 8009. On the other hand, if no virtual name is found in namespace table 1205 for the selected real name for the identified client ID, then it may be assumed that a virtual name is identical to its real name and the real name does not need to be converted, and the process goes to step 8010.

Returning to step 8003, if the response includes a file handle in addition to the selected real name, then at step 8004, storage system control program 1206 obtains a real name which corresponds to the file handle which is maintained by the storage system as a part of well-known file system management techniques. The real name obtained is usually a full path of a directory which contains a file system object specified by the selected name in the response.

At step 8005, a full real name is obtained by concatenating the real name obtained at step 8004 with the selected real name included in the response.

At step 8006, storage system control program 1206 refers to namespace table 1205 and searches real names in the namespace table 1205 for a real name corresponding to the concatenated name for the identified client ID. If the real name is found for the identified client ID, then the corresponding virtual name registered in the namespace table needs to be returned with the response.

At step 8007, if no real name in namespace table 1205 matches the concatenated name for the identified client, then the selected real name is identical to its virtual name and does not have to be converted, and the process skips to step 8010. On the other hand, if the concatenated name matches a real name 2003, then there is a corresponding virtual name 2002 registered in namespace table 1205 for the identified client ID, and then the process goes to step 8008.

At step 8008, storage system control program 1206 extracts the base name of the virtual name, i.e., the last component of the virtual name. Since the original real name included with the response was determined to correspond to a virtual name, the real name needs to be replaced in the response with the virtual name. Additionally, since the response includes a file handle, only the base portion of the virtual name replaces the real name in the response.

At step 8009, the process replaces the selected original real name in the response with the virtual name obtained at step 8008 or 8012.

At step 8010, the process determines whether all names in the response have been selected and processed. Steps 8002-8013 are repeated until all names in the response have been selected and processed, and then the process for converting names ends, and the main process of FIG. 4B proceeds to step 4011.

From the foregoing discussion it may be seen that by using this invention, configuration information which defines the mapping between each client and file system objects, such as files and directories, are consolidated and stored in the storage system. When the configuration is changed, the administrator can edit at the management server and simply restart clients, rather than logging in to each of the affected clients and editing the configuration information for each client. In the embodiments discussed above, NFS operations are enumerated as examples. However, the invention can also be applied to other network file system interface protocols, such as CIFS. Furthermore, the invention may be applied to storage systems other than NAS systems, such as Content Aware Storage (CAS) systems, or other storage systems implementing file systems and file handles.

The invention is used to provide a method and apparatus to convert names of objects included in file system operations issued from client computers or in responses issued to client computers according to configuration information maintained in the storage system, so that each client may issue identical operations but accesses different data or file system objects. Typically, large NAS systems contain a large number of files and are shared by multiple host computers. If the NAS system has multiple tiers which consist of various disk drives and other storage media, the location of each file must be managed by the administrator in the prior art. Accordingly, the present invention simplifies the management requirements for accomplishing these tasks by virtualizing the namespace for file system objects accessed by a plurality of client computers.

Thus, it may be seen that the invention provides virtualized namespaces for each client of a storage system. Further, while specific embodiments have been illustrated and described in this specification, those of ordinary skill in the art appreciate that any arrangement that is calculated to achieve the same purpose may be substituted for the specific embodiments disclosed. This disclosure is intended to cover any and all adaptations or variations of the present invention, and it is to be understood that the above description has been made in an illustrative fashion, and not a restrictive one. Accordingly, the scope of the invention should properly be determined with reference to the appended claims, along with the full range of equivalents to which such claims are entitled.

What is claimed is:

1. A method of operating a storage system, comprising:
maintaining at the storage system a first information holding a correspondence between real names for file system objects and virtual names for the file system objects, said virtual names being registered in said first information according to individual clients in communication with the storage system;
receiving at the storage system an operation request from one of the clients;
determining whether the operation request includes a first said virtual name for a first one of said file system objects that is a target of the operation request;
replacing the first virtual name in the operation request with a corresponding first real name by referring to said first information and an ID of the one of the clients that sent the operation request; and
carrying out said operation request using said first real name in said operation request in place of said first virtual name.

2. A method according to claim 1, further including a step of
determining whether a response to the operation request includes a second real name for a second one of the file system objects; and
replacing the second real name with a corresponding second virtual name for the second file system object in said response by referring to said first information, said corresponding second virtual name being registered in said first information for a client that is a target of said response.

3. A method according to claim 1, further including steps of
determining whether the operation request includes a file handle;
determining a virtual name corresponding to said file handle;
concatenating the virtual name with a selected name included in said operation request to create a concatenated name; and
referring to said first information to determine said first real name for replacing the first virtual name in the operation request.

4. A method according to claim 1, further including steps of
maintaining a second information in said storage system, said second information holding a relationship between file handles and virtual names for said file system objects.

5. A method according to claim 4, further including steps of
determining whether a new file handle was generated in response to the operation request;
determining a second real name for a second one of the file system objects corresponding to new the file handle;
referring to said first information to locate a second said virtual name that corresponds to the second real name and a client ID of a said client that is a target of the response; and
updating the second information maintained in the storage system with the new file handle and said second virtual name.

6. A method according to claim 5, further including steps of
determining whether the operation request resulted in the deletion of a file handle;
determining a second real name corresponding to the deleted file handle;
referring to the first information to determine a second virtual name that corresponds to the second real name and a client ID of a said client that is a target of a response of the operation request; and
deleting from the second information the second virtual name and a corresponding file handle information.

7. A method according to claim 1, further including steps of
editing said first information at a management server in communication with said storage system to add or delete said virtual names registered in said first information for said clients; and
uploading said edited first information to said storage system for use in determining said correspondence between said real names for file system objects and said virtual names for the file system objects according to individual said clients.

8. A storage system, comprising:
a processor, a memory, and one or more storage devices for storing data, said storage system configured to present one or more file systems to one or more client computers in communication with said storage system,
wherein the storage system maintains a first information holding a correspondence between real names for file system objects and virtual names for the file system objects, said virtual names being registered in said first information according to individual clients in communication with the storage system;
wherein when said storage system receives an operation request from one of the clients, said storage system determines whether the operation request includes a first said virtual name for a first one of said file system objects that is a target of the operation request,
wherein said storage system replaces the first virtual name in the operation request with a corresponding first real name by referring to said first information and an ID of the one of the clients that sent the operation request, and carries out said operation request using said first real name in said operation request in place of said first virtual name.

9. A storage system according to claim 8, further comprising
wherein said storage system determines whether a response to the operation request includes a second real name for a second one of the file system objects, and
wherein said storage system replaces the second real name with a corresponding second virtual name for the second file system object in said response by referring to said first information, said corresponding second virtual name being registered in said first information for a client that is a target of said response.

10. A storage system according to claim 8, further comprising
wherein said storage system determines whether the operation request includes a file handle, and determines a virtual name corresponding to said file handle, and
wherein said storage system concatenates the virtual name with a selected name included in said operation request to create a concatenated name, and refers to said first information to determine said first real name for replacing the first virtual name in the operation request.

11. A storage system according to claim 8, further comprising
wherein said storage system maintains a second information in said storage system, said second information holding a relationship between file handles and virtual names for said file system objects.

12. A storage system according to claim 11, further comprising
wherein said storage system determines whether a new file handle was generated in response to the operation request, and determines a second real name for a second one of the file system objects corresponding to new the file handle, and
wherein said storage system refers to said first information to locate a second said virtual name that corresponds to the second real name and a client ID of a said client that is a target of the response, and updates the second information maintained in the storage system with the new file handle and said second virtual name.

13. A storage system according to claim 11, further comprising
wherein said storage system determines whether the operation request resulted in the deletion of a file handle, and determines a second real name corresponding to the deleted file handle, and
wherein said storage system refers to the first information to determine a second virtual name that corresponds to the second real name and a client ID of a said client that is a target of a response of the operation request, and deletes from the second information the second virtual name and a corresponding file handle information.

14. A storage system according to claim 8, further comprising
a management server in communication with said storage system,
wherein said first information is edited at said management server to add or delete said virtual names registered in said first information for said clients; and
wherein said management server uploads said edited first information to said storage system for use in determining said correspondence between said real names for file system objects and said virtual names for the file system objects according to individual said clients.

15. A method of operating a storage system, comprising:
placing said storage system into communication with a first client computer and a second client computer;
maintaining at the storage system a first information said first information holding a correspondence between real names for paths for file system objects and virtual names for the paths, said virtual names being individually registered in said first information according to said first client computer or said second client computer;
receiving at the storage system a first operation request from the first client computer;
determining whether the first operation request includes a first said virtual name for a first one of said file system objects that is a target of the first operation request;
replacing the first virtual name in the operation request with a corresponding first real name by referring to said first information and an ID of the first client computer that sent the first operation request; and
carrying out said first operation request using said first real name in said operation request in place of said first virtual name.

16. A method according to claim 15, further including a step of
receiving at the storage system a second operation request from the second client computer;
determining whether the second operation request includes a second said virtual name for a second one of said file system objects that is a target of the second operation request;
replacing the second virtual name in the second operation request with a corresponding second real name by referring to said second information and an ID of the second client computer that sent the second operation request; and
carrying out said second operation request using said second real name in said operation request in place of said second virtual name,
wherein said second virtual name is identical to said first virtual name, and said second real name designates the second file system object which is different from the first file system object designated by said first real name.

17. A method according to claim 15, further including a step of
determining whether a response to the first operation request includes a second real name for a second one of the file system objects; and
replacing the second real name with a corresponding second virtual name for the second file system object in said response by referring to said first information, said corresponding second virtual name being registered in said first information for a client computer that is a target of said response.

18. A method according to claim 15, further including steps of
determining whether the first operation request includes a file handle;
determining a virtual name corresponding to said file handle;
concatenating the virtual name with a selected name included in said operation request to create a concatenated name; and
referring to said first information to determine said first real name for replacing the first virtual name in the first operation request.

19. A method according to claim 15, further including steps of
maintaining a second information in said storage system, said second information holding a relationship between file handles and virtual names for said file system objects.

20. A method according to claim 15, further including steps of
editing said first information at a management server in communication with said storage system to add or delete said virtual names registered in said first information for said clients; and
uploading said edited first information to said storage system for use in determining said correspondence between said real names for file system objects and said virtual names for the file system objects according to individual said clients.
